(19) United States
(12) Patent Application Publication
(10) Pub. No.: US 2017/0088436 A1
(43) Pub. Date: Mar. 30, 2017

(54) System and method for residential and industrial grey water recycling and filtration process and system

(71) Applicant: VertAqua LLC, Mill Creek, WA (US)

(72) Inventors: Sergio Luis Espinoza, La Habra, CA (US); David Axel Virzi, Mill Creek, WA (US)

(73) Assignee: VertAqua LLC, Mill Creek, WA (US)

(21) Appl. No.: 14/867,008

(22) Filed: Sep. 28, 2015

(51) Int. Cl. C02F 1/00; B01D 61/02; C02F 9/00; C02F 1/44; C02F 1/28

(52) U.S. Cl. CPC C02F 1/008; C02F 1/441; C02F 1/283; C02F 9/00; B01D 61/025; C02F 2103/002

(57) ABSTRACT

A method and process for deploying a stand-alone system for recycling and processing residential and/or industrial grey water. System includes measuring and recording sensor data for indicating incoming grey water quality, deterministic conditional logic algorithm for recycling, processing and reintroducing grey water to drinking and non-drinking water systems in both residential and/or industrial platform. The process disclosed in this filing aims to describe a water recycling system that brings together several sub-systems in order to create a high level process for grey water recycling. The process presents a linear series design in which grey water will pass each sub-system in a linear fashion and will progressively become cleaner as it is pushed to the next sub-system.

### FIELD OF THE DISCLOSURE

The present disclosure is related to filtration/recycling water systems. More particularly, the present disclosure relates to a grey-water filtration/recycling process and system for residential, commercial, and/or industrial platforms.

### BACKGROUND

Two-thirds of the world's surface is covered in water, however only a small fraction is categorized as viable fresh drinking water. Per National Geographic, this percentage is roughly 2.5%, while the rest is defined as undrinkable seawater, or frozen fresh water. The combination of global-wide record setting fresh water intake and the common occurrences of droughts demand and require an urgent solution for alleviating the high rate of fresh water consumption by society. Society and fresh water share a special relationship, where increases in population, increase the need for sustainable freshwater sources. Likewise, limited availability of freshwater greatly reduces the survival of any society. It is this special “society to freshwater” relationship and the expected increase in global agricultural water consumption that invokes a need for a system which can alleviate the stress on freshwater sources. The present disclosure emphasizes the capability of being able to address such concerns by employing a standalone system and process for recycling residential and industrial grey water.

All residential and industrial's waste water regardless of their classification (black or grey) are currently processed to some extent by the waste and water management facilities of their particular cities. Some of these facilities have the capability to process and recycle several thousand gallons of water per day. The treated water is then distributed throughout the entire city and used for several different purposes i.e; meeting residential, commercial and industrial demands. Per the Environmental Protection Agency, costs associated with municipal reclaimed water facilities are great and generally exceed the cost of potable water in many regions of the world, where fresh water supply is plentiful. The costs are generally associated with large scale industrial equipment and filtration systems that are used to clean thousands gallons of water per day. While the technology itself is not expensive, it is rather that large amount of water it must process daily that accounts for the high costs.

According to the Environmental Protection Agency, many water treatment facilities stop short of returning black or grey water into fresh drinking water, mainly due to the lack of infrastructure capital. Greywater is defined as all wastewater streams generated from residential, and commercial structures with the exception of wastewater from toilets. Sources of greywater in residential platforms include sinks, showers, bathtubs, washing machines, and dish washers. In comparison, black water is the term used to indicate water that contains human waste or other forms of sewage, and thus will typically include far more pathogens and bacteria than greywater. Therefore, processing and recycling greywater is substantially less extensive and difficult. Once the grey water has been processed it can serve to feed several different residential and/or industrial fresh water recipients such as, toilets, showers, sinks, washing machines, pools, lawns/agricultural land as well as for typical cooking and drinking purposes.

In the current market, several platforms currently exist aimed at recycling greywater and repurposing this volume elsewhere however these existing systems do not treat grey or black water but just primarily redirected the unprocessed greywater for gardening and/or toilet flushing purposes. Through extensive market research, no solutions were found with the capability of being able to recycle water for an entire residential, commercial, and/or industrial platform. A small amount of companies target recycling water for the purposes of returning it to potable water. However, these systems are solely focused on large scale industrial applications and not suited for a residential or commercial environments.

The system and method targeted in this patent application is that of one that will recycle all greywater in a household or commercial building. The water will be restored to clean drinking water standards and then fed back into the inlet water line for reuse. This process can be repeated several times as long as the water quality is maintained. This process brings water recycling to individual homes and commercial buildings, providing the consumer the advantage of cost savings as well as minimizing overall water demand in cities, states, and country.

In making a first application of its kind one challenge that presents itself is processing the greywater to levels acceptable for drinking and cooking. The final water product that is recirculated to the inlet of the residential or commercial platform must satisfy all residential distribution regulations.

The process involves first routing the greywater to a junction water holding tank. When the junction holding tank reaches a certain water level, a pump pushes the water through several large particle filters to rid the water of physical particulates and other contaminants. Once the water passes the first stage filtration, it then undergoes a reverse osmosis process which primarily is made up of several preliminary filters before being pressured through a membrane filter used to eliminate bacteria and pathogens. The processed water then passes through a final bacterial elimination process with an ultraviolet light filter. Two subsequent carbon filters then provide a final cleansing and provide a more familiar taste.

Once the water has undergone the entire filtration system it is then stored in a reservoir tank which contains instrumentation/sensors capable of validating the water quality. If the water quality does not meet national regulations and/or standards then the entire reservoir is emptied and the water is discharged into the return line of the residential/commercial platform which commonly leads to the city's sewage system. Discharging the water ensures that only drinkable water is returned to the inlet of the residential/commercial platform.

The present disclosure is intended to address one or more of the above issues.

### SUMMARY

It has been recognized that it would be desirable to have a stand-alone system that can process and recycle residential or commercial grey water.

It has also been recognized that it would be desirable to have an automated software with the ability to process and recycle grey water and also determine whether the quality of the recycle water meets national standards.

In accordance with one aspect thereof, the present disclosure provides a method for system level greywater purification.

In accordance with another aspect thereof, the present disclosure provides a method for system level greywater restoration to drinking water standards.

In accordance with yet another aspect thereof, the present disclosure provides a system for recycled water storage and monitoring.

### BRIEF DESCRIPTION OF THE DRAWINGS

FIG. 1 is a high level system diagram of an embodiment of the standalone grey water process and recycling system.

FIG. 2 is a drawing of the stand-alone grey water recycling system.

FIG. 3 (a) is a flowchart showing first stage of the logical methods used for the overall system up to the logical sequence of the system verifying water quality for determining whether to process the obtain grey water.

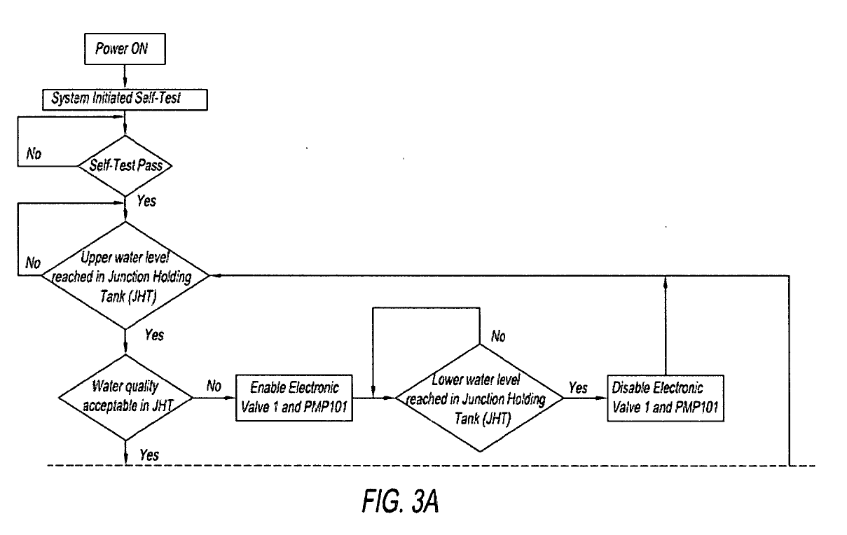

FIG. 3 (b) is a flowchart continuing the logical methods used in the overall system's algorithm. This flowchart sequence shows the second stage of the logical procedure used up to the system verifying grey water quality in the reservoir tank. The flowchart sequence shown in this figure is the continuation from FIG. 3(a).

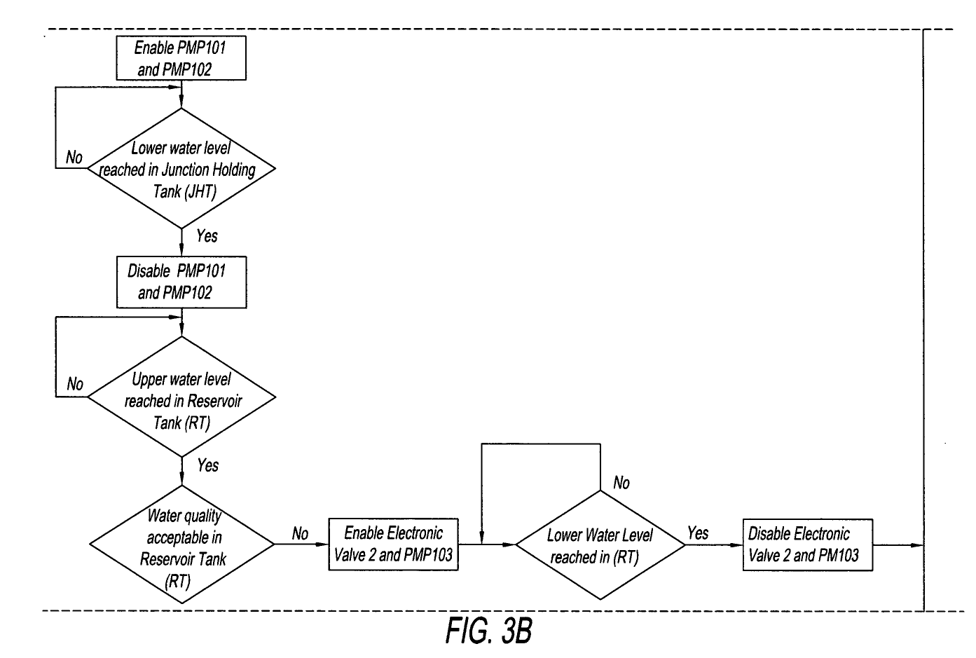

FIG. 3 (c) is a flowchart continuing the logical methods used in the overall system algorithm. The flowchart sequence shows the logical procedure used in the last stage of the system's algorithm. This portion of the algorithm performs the final actions in order to re-introduce the recycled grey water back into the residential or industrial platform. The flowchart sequence shown in this figure is the continuation from FIG. 3(b).

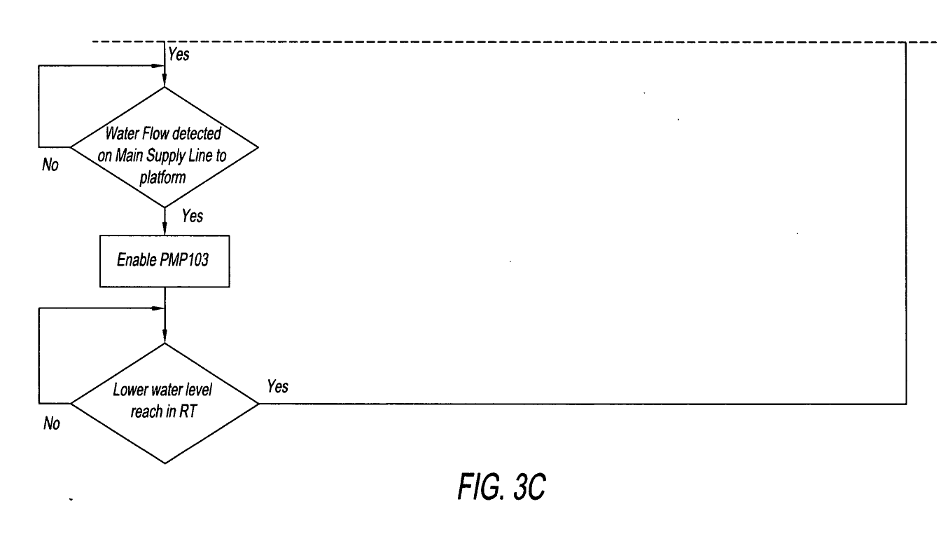

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

As noted above, current water processing and treatment takes place in city waste and management facilities. These facilities treat and re-introduce the water into city supply lines which then distribute the water to the entire city. Some cities treat and process only a small fraction of the entire city's wastewater. In these specific cities the water is redirected to nearby oceans, lakes, or rivers. An application and method of being able to contain local grey water, treat/process, and reintroduce at a residential and commercial platform level has not previously been done or deployed before. More specifically, being able to monitor several variables to determine water quality prior to re-introducing it the subjected platform proves of some difficulty. Dealing with greywater, water treatment, re-introduction to water supply lines and the deterministic algorithm associated with such a system capable of handling such a task are also issues of concern.

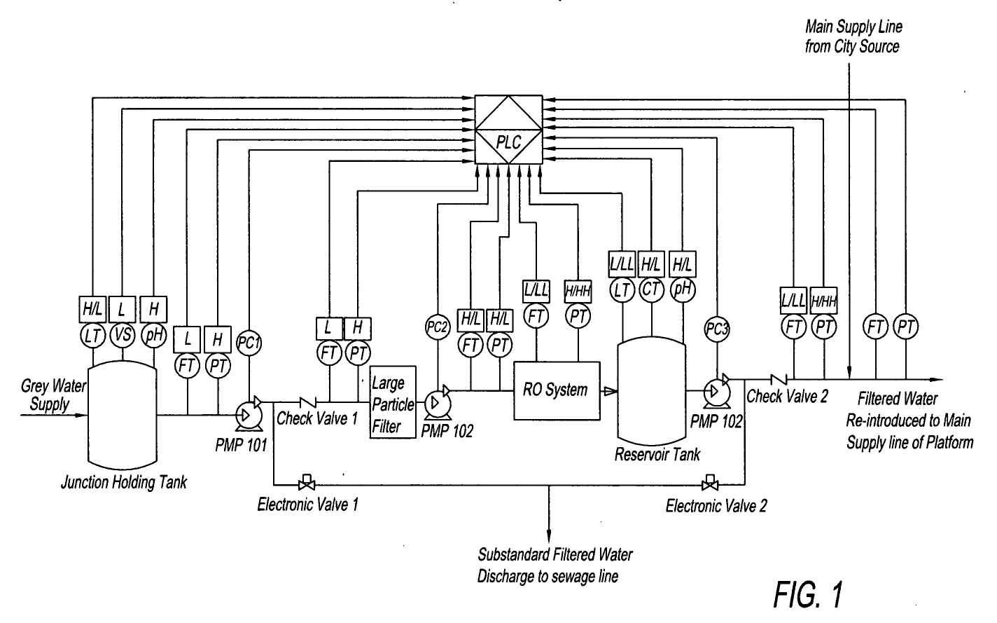

Beneficially, a system and method have been developed for localizing wastewater, with the ability to treat, monitor, and re-supply residential or commercial platforms. Shown in FIG. 1 is a top level schematic diagram of such a system. As shown in FIG. 1, the system contains several discrete components such as a series of different types of sensors, valves, and pumps. All actions and logic are executed through the programmable logic controller. The PLC contains and executes the deterministic algorithm that controls the entire system. The PLC works in conjunction with several different types of sensors for determining what actions to execute.

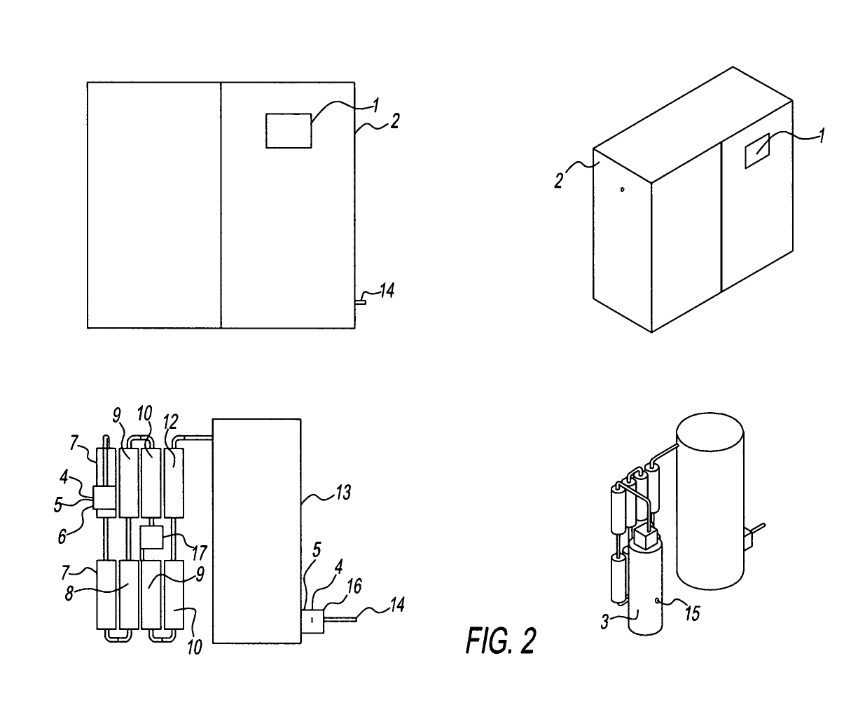

Per FIG. 1 and FIG. 2, the greywater enters the system and first resides in the Junction Holding Tank (Item 3). The holding tank (Item 3), temporary contains the incoming greywater until the system is ready for transfer. Fluid level sensors are located inside of the junction holding tank, once the greywater level hits an upper water capacity limit indicated by such a sensor the programmable logic controller is notified. The PLC will then initiate the process to transport the greywater out of the junction holding tank.

In addition to the level sensors, viscosity and pH sensors also reside inside of the junction holding tank. These sensors are in place in order to determine the water quality of the incoming greywater. The system will analyze the incoming greywater via these sensors in order to determine if the greywater contains the minimum characteristics to undergo the water treatment process of the system.

Once the process of transferring the greywater out of the holding tank is initiated both PMP 101 (Item 6) and PMP 102 (Item 17) are simultaneously enabled. PMP 101 (Item 6) relocates the greywater out of the holding tank to the next stage of the water treatment system, while PMP 102's (Item 17) vital role is that of inlet pump for the reverse osmosis subsystem. As the inlet pump for the RO system, it pushes the greywater through the several in series filters and into the reservoir tank.

However, if the greywater quality inside of the holding tank exceeds the capability of what the system can treat and process then electronic valve 1 is enabled and PMP 102 (Item 17) is disabled. Enabling electronic valve 1 flushes the highly contaminated greywater to the drain line of the residential or commercial platform. The flushing of the highly contaminated greywater prolongs the life of the system, eliminates the processing and treatment of untreatable water, and ensures the likelihood that the end result quality of the water that is re-introduce to the platform is of drinking quality.

Both PMP 101 (Item 6) and PMP 102 (Item 17) are commanded by the system's programmable logic controller, once both pumps are turned on the greywater is transported past the first check valve. Check valve 1 (Item 4) is in place in order to ensure that no water is feed back into the holding tank once the pumps are turned off. PMP 101 (Item 6) and PMP 102 (Item 17) continue to push the water out of the junction holding tank until the lower water capacity limit is reached. Flow and pressure sensors are both located pre and post PMP 101 in order to ensure that the appropriate flow rate and pressures are being reached. The sensors also indicate to the PLC if any water flow restriction or leaks are present since these will be seen as high pressure and/or low flow rate readings.

A two stage carbon filtration sub-system (Item 7) is placed between check valve 1 (Item 4) and the RO subsystem. The two stage carbon filters act as an initial filtration by removing larger debris and particulates that may be found within the water. While also serving as the initial filtration process. This two stage carbon filtration sub-system also acts as a protection barrier to the rest of the recycling/filtration system by impeding large containments from moving further downstream in the system.

The reverse osmosis system that has been designed as part of this water recycling system is comprised of a few individual parts that operate in series as the water flows through it. Water first flows through a large pore sediment filter (Item 8) in order to eliminate any large particulates that may damage other parts downstream. At the 2^{nd} stage, the water will then pass through a second sediment filter (Item 9) that has a much smaller pore design in order to further capture particulates and other debris. The 3^{rd} stage will run water through a standard carbon filter (Item 10) in what will make up the first cleaning process. The 4^{th} stage will have water running through a thin film membrane filter (Item 11). This filter is designed with microscopic pores that rid the water of larger bacteria and other impurities. In order for the 4^{th} stage to function properly, the flow rate must be accelerated by a water pump in order to get a desired high rate of flow through the membrane filter. The 5^{th} stage is the second carbon filter (Item 10) of the system which will provide additional surface cleansing and generate a familiar taste in water. The 6^{th} stage is an ultra violet light filtration system (Item 12). This stage will clean any remaining bacteria or toxins that remain in the water. The flow rates and pressure throughout the reverse osmosis system will be regulated by our control system that will utilize sensors and pumps to monitor the optimum parameters to ensure a proper cleansing process.

The reverse osmosis sub-system of the process is considered to be a core and essential step in our proposed design. Depending on application and water usage, maintenance schedules will be determined in order to ensure all filters remain in optimum performance. As will be stated later in this document, the system design has provisions in place to handle bacteria and toxins that remain in the water even after passing our rigorous cleansing process.

After the water undergoes the reverse osmosis process it is then store in the system's Reservoir Tank (Item 13). The reservoir tank (Item 13), was designed to not only be a temporary storing container for the processed water but also as a quality control apparatus where the overall quality of the processed water is analyzed and validated. The reservoir tank incorporates various sensors that read numerous characteristics and properties of the treated water. Some of these water characteristics are temperature, conductivity, dissolved oxygen, pH level, turbidity, and oxygen redox.

Using all the necessary and available data from the sensors the system's controller determines if the quality of the water is that of which satisfies drinking standards. If the processed water is deemed of drinking quality then the reservoir tank can be discharged into the main supply line when the water recipients in the residential or commercial platform are in used. The system detects when water is being used on the platform by measuring the flowrate of the main supply line. If flow is detect then the system enables PMP 103 (Item 16). PMP 103 (Item 16) in return drains the reservoir tank and pressurizes the water into the main supply line through check valve 2 (Item 4). However, if the water quality of the treated water is not up to drinking standards then the entire reservoir tank is emptied. The subpar water is discharged out of the reservoir tank and into the city's sewage system via the sewage line of the residential or commercial platform.

All the above mentioned sub-systems are housed within a containment (Item 1) that features a graphical user interface (Item 2) that will display data about the performance of the system as well as other pertinent data points. The containment will contain Ethernet connectivity in order for the system to be integrate, monitored, and if necessary controlled. The algorithm of the software will allow the logic controller to perform several automated functions without any intervention required from the user. This aims to provide the user a hands free approach to their water recycling needs.

What is claimed is:

1. A method for residential and industrial grey water recycling filtration process system, the method comprising:
a junction water holding tank for system startup and initial water quality determination.
a two stage carbon filtration system for large particulates;
a reverse osmosis system, for bacterial and contaminant cleansing
a reservoir tank for final processed water storage and analysis
a containment housing for equipment mounting and system to platform integration, and
deterministic conditional logic algorithm for determining overall system states and process.

2. The method in claim 1, will implement rerouted plumbing to only collect the platform's grey water supply. This modification to the platform's plumbing drain lines allows the grey water to be collected into the junction water holding tank to start the recycling process.

3. The method in claim 1, has the reservoir tank connected to the platform's main water supply line. Through this connection the system introduces the recycled grey water once water usage in the platform is detected.

4. The method in claim 1, connects to the platform's main drain line and introduces any processed grey water which is not satisfactory to drinking water standards from either the system's junction water holding tank and/or reservoir tank.
